(19) United States
(12) Patent Application Publication
(10) Pub. No.: US 2005/0254890 A1
(43) Pub. Date: Nov. 17, 2005

(54) Shaft-hub connection

(76) Inventors: Horst Schulz, Friedrichshafen (DE); Tino Kirschner, Eriskirch (DE); Roland Buchmann, Friedrichshafen (DE)

Correspondence Address: DAVIS & BUJOLD, P.L.L.C., FOURTH FLOOR, 500 N. COMMERCIAL STREET, MANCHESTER, NH, 03101-1151, US

(21) Appl. No.: 10/524,812

(22) PCT Filed: Aug. 23, 2003
(86) PCT No.: PCT/EP03/09372

§ 371 Date: Feb. 18, 2005

(30) Foreign Application Priority Data
Aug. 28, 2002 (DE) 102 39 393.1

(51) Int. Cl. B25G 3/28

(52) U.S. Cl. 403/359.1

(57) ABSTRACT

A shaft-hub connection between one shaft segment comprises one central toothed segment, the same as adjacent centering segments and one stepped hole in a hub, in which the shaft and the hub are jointed in axial direction and by the toothed shaft segment a positive fit is formed with the hub, in which the front centering segment, lying in joint direction, has a diameter d1 and the toothed shaft segment, the same as the rear centering segment lying in joint direction, has a diameter d2 larger than d1. It is proposed that the hole has only two adjacent segments I, II of different diameters D1 and D2, that the diameter d1 in the centering segment with the diameter D1, the same as the diameter d1 in the centering segment with the diameter D2, form a respective joint fit and the diameter d2 in the area with the diameter D1 forms the positive fit.

According to the preamble of claim 1, the invention concerns a shaft-hub connection known by EP-B 0 784 759.

The shaft-hub connection disclosed in EP-B 0 784 758 consists of one shaft end having three segments which is inserted in a three-step hole of a hub, i.e., a hole with three hole segments of different diameters. The central shaft segment has one toothing which digs into the central hole segment when the two parts are axially jointed, thus producing a clamping between shaft and hub. The two adjacent shaft segments, so-called centering segments, form a respective joint fit with the corresponding hole segments of the hub. In direction to the joint and the toothed shaft segment, the rear centering segment can have the same diameter or different diameters as known from EP-B 661 474. Disadvantageous in this known shaft attachment is the manufacturing technical expense, especially for the hub designed with a three-step hole, each hole requires still more production cost as fitting hole.

The problem on which the invention is based is to produce a shaft-hub connection of the above mentioned kind which can be manufactured at lower cost with the same fitting or centering precision.

This problem is solved by a shaft-hub connection having the features of claim 1. The essential advantage of the inventive shaft attachment consists in that the hub has only two more segments of different diameters, i.e., only one two-step hole, unlike the three-step hole of the prior art. This essential simplification in technical production of the hub hole results from the realization obtained by the invention that the hole diameter for the front centering segment is the same diameter in which digs the toothing of the central shaft segment. An essentially simpler and thus more economically produced hub hole is thus achieved with the same centering precision as in the prior art.

In an advantageous development of the invention, one other smaller diameter is provided between the toothed shaft segment and the front centering segment lying in joint direction which corresponds to the root diameter of the knurled toothing of the toothed segment. Thereby results the advantage of a simple production of the knurled toothing by a knurling tool which can be more easily delivered.

In another development of the invention, the centering segment lying behind in joint direction changes over to a shaft collar which serves as stop surface against the front face of the hub during the jointing of shaft and hub. This results in a small axial depth for the shaft segment.

In the drawing is shown one embodiment of the invention which is described in detail herebelow. In the drawing:

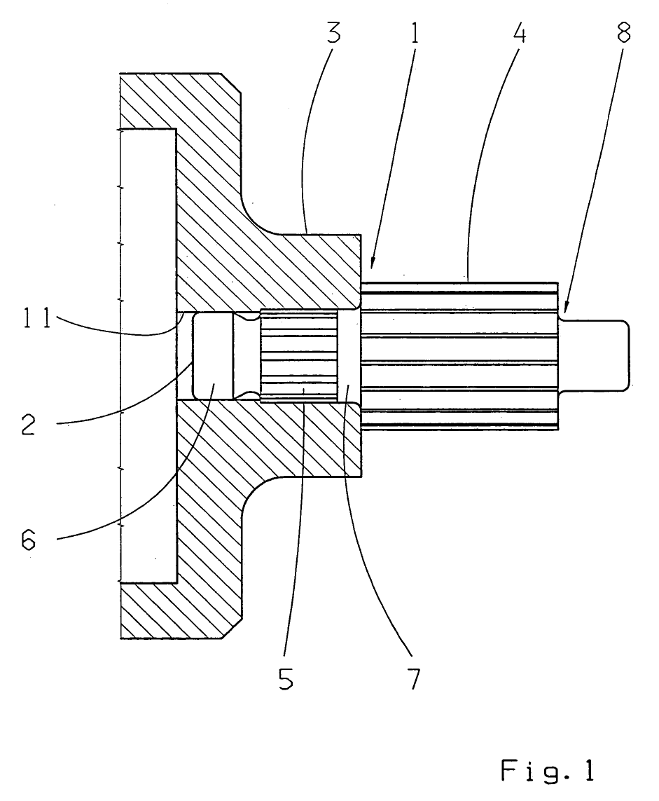

FIG. 1 is a shaft-hub connection in assembled state;

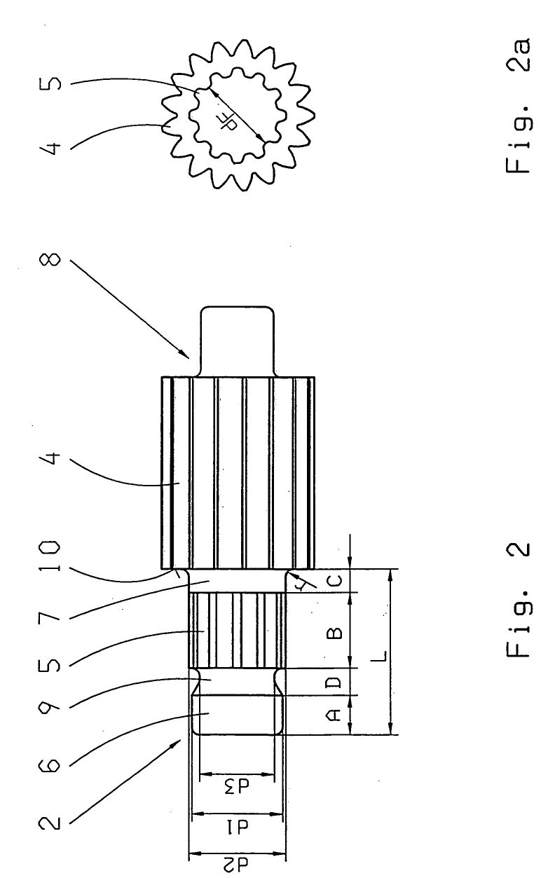

FIG. 2 is a shaft segment of the shaft-hub connection according to FIG. 1;

FIG. 2A is a side view on the shaft segment with pinion; and

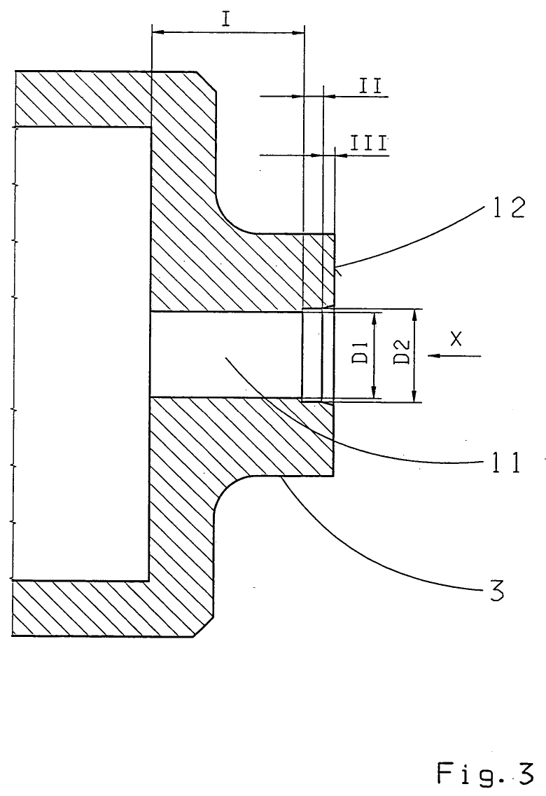

FIG. 3 is the hub of the shaft-hub connection according to FIG. 1.

FIG. 1 shows a shaft-hub connection 1 between one shaft segment 2 and one hub 3 of a transmission part (not shown in detail). The shaft segment 2, which is integrally connected with a pinion 4, forms 3 a positive fit connection with the hub 3 by way of a toothed shaft segment 5 which cuts into the hub 3 while the shaft segment 2 is being jointed. Centering segments 6, 7 are on both sides of the toothed shaft segment 5. The pinion 4 and the shaft segment 2 form one pinion shaft 8 which is part of a transmission (not shown).

FIG. 2 shows the pinion shaft 8 of FIG. 1 as a separate part with the shaft segment 2 which has an axial extension L. The shaft segment 2 has four segments, namely, the front centering segment 6 with the width A; the central toothed shaft segment 5 with the width B; the rear centering segment 7 in joint direction with the width C, and one groove 9 with the width D. The segments 5, 7 of the widths B plus C have the same external diameter d2. The front centering segment of the width A has a smaller diameter d1. Between the toothed segment B and the front centering segment A is situated the groove 9D with a diameter d3 which is smaller than d1; it corresponds to the root diameter dF such as plotted in a side view in FIG. 2a. The toothing of the shaft segment 5 is a knurled toothing produced by a roller tool. The toothing shaft segment 5 extends with its root area into the segment D whereby the production of the knurled toothing is simplified. The rear centering segment 7, lying in joint direction passes with a radius r into a shaft collar 10 which forms the front face of the pinion 4.

FIG. 3 shows the hub 3 with a hole 11 as separate part. The hole 11 has two segments, namely, a first segment I with a diameter D1 and a second segment II with a diameter D2 larger than D1. To the cylindrical segment II attaches a chamfered segment III to brake the outer edge of the hole.

The diameters d1, d3 of the shaft segment 2 and the diameters D1 and D2 of the hole 11 are coordinated in a manner such that d1 for the shaft segment 6 with D1 in the hole segment I, the same as d2 in the segment 7 with D2 in the hole segment II, yield joint fit, i.e., slip, sliding or tight fit. The diameter d2 of the toothed shaft segment 5 is larger than the hole diameter D1—wherefore the toothing of the shaft segment 5 cuts into the hole segment I via a width B.

The parts 8 or 2 and 3 are jointed so that the pinion shaft 8 is first co-axially aligned with the hole 11 and then introduced in axial direction X into the hole 11. At the same time, the front segment 6, lying in joint direction with the diameter d1 at first assumes the centering until the toothed segment 5 reaches, first, the hole segment II subsequently the hole segment I and then cuts in a counter profile in the hub 3. Finally, the collar 10 of the pinion shaft 8 comes to abut on the front face 12 of the hub 3 and the jointing process is terminated. The centering segment 7 is then in the hole segment II and forms a joint fit with the diameter D2. The radius r of the centering segment 7 is here free due to the chamfered segment III. By virtue of the centering segments 6, 7 on both sides of the toothed shaft segment 5, a play-free, precise fit, centered bearing results for the pinion shaft 8 and the pinon 4 which is important for a precise tooth contact with other gear wheels (not shown).

### REFERENCE NUMERALS

1 shaft-hub connection 7 centering segment

2 shaft segment 8 pinion shaft

3 hub 9 groove

4 pinion 10 collar

5 toothed shaft segment 11 hole

6 centering segment 12 front face

1-4. (canceled)

5. A shaft-hub connection (1) between a shaft segment (2), which has one central toothed segment (B), the same as adjacent centering segments (A, C), and a stepped hole (11) in a hub (3), a shaft (2) and a hub (3) being jointed in axial direction (X) and, to produce a positive fit (5), a counter profile is cut in the hub (3) by the toothed segment (B), a front centering segment (A) in joint direction has a diameter (d1) and the toothed segment (B), the same as a rear centering segment (C) lying in joint direction, has a diameter (d2) larger than the diameter (d1) of the front centering segment (A), the hole (11) has only two adjacent segments (1, 11) with different diameters (D1, D2), that the diameter (d1) in the front centering segment (A) with a diameter (D1), the same as the diameter (d2) in the rear centering segment (C) with a diameter (D2), forms a respective joint fit and the diameter (d2) in the central toothed segment (B) with the diameter (D1) forms the positive fit (5).

6. The shaft-hub connection according to claim 5, wherein between the central toothed segment (B) and the front centering segment (A) one other segment (D) is located which has a diameter (d3) smaller than the diameter (d1 ) of the front centering segment (A).

7. The shaft-hub connection according to claim 6, wherein the toothed segment (B) has one knurled toothing (5) with a root diameter (dF) and that the diameter(d3) is ≦the root diameter (dF).

8. The shaft-hub connection according to claim 5, wherein the centering segment (C) changes over to a shaft collar (10) which abuts on a front face (12) of the hub (3).

9. A shaft-hub connection (1) between a shaft segment (2) and a hub (3), the shaft segment (2) having one central toothed segment (B) and adjacent centering segments (A, C), the hub (3) having a stepped hole (11), the shaft segment (2) and hub (3) being jointed in an axial direction (X) and to produce a positive fit (5) a counter profile is cut in the hub (3) by the central toothed segment (B), a front centering segment (A) in a joint direction has a first diameter (d1), the central toothed segment (B) and the rear centering segment (C) lying in the joint direction have a second diameter (d2), the second diameter (d2) is larger than the first diameter (d1), the stepped hole (11) has a third segment (I) with a third diameter (D1) and a fourth segment (II) with a fourth diameter (D2), the first diameter (d1) is approximately equal to the third diameter (D1), the second diameter (d2) is approximately equal with to fourth diameter (D2), the front centering segment (A) of the shaft segment (2) and the third segment (I) of the stepped hole (11) forming a joint fit, the rear centering segment (C) of the shaft segment (2) and the fourth segment (II) of the stepped hole (11) forming another joint fit, the rear centering segment (C) of the shaft segment (2) and the third segment (I) of the stepped hole (11) forming a positive fit (5).

10. The shaft-hub connection according to claim 9, wherein one additional segment (D) is located between the front centering segment (A) and central toothed segment (B) and has a third diameter (d3) smaller than the first diameter (d1).

11. The shaft-hub connection according to claim 10, wherein the central toothed segment (B) has one knurled toothing (5) with a root diameter (dF), the third diameter (d3) is less than or approximately equal to the root diameter (dF).

12. The shaft-hub connection according to claim 9, wherein the rear centering segment (C) changes into a shaft collar (10) which abuts on a front face (12) of the hub (3).
